(19) United States
(12) Patent Application Publication
(10) Pub. No.: US 2020/0201091 A1
(43) Pub. Date: Jun. 25, 2020

(54) LIQUID CRYSTAL DISPLAY PANEL

(71) Applicant: SHARP KABUSHIKI KAISHA, Sakai City, Osaka (JP)

(72) Inventors: KIMIAKI NAKAMURA, Sakai City, Osaka (JP); TAKASHI KATAYAMA, Sakai City, Osaka (JP); TAKAHIRO SASAKI, Sakai City, Osaka (JP); SHINPEI HIGASHIDA, Sakai City, Osaka (JP); KAZUTAKA HANAOKA, Sakai City, Osaka (JP); HIDEFUMI YOSHIDA, Sakai City, Osaka (JP)

(21) Appl. No.: 16/613,060

(22) PCT Filed: May 14, 2018
(86) PCT No.: PCT/JP2018/018448

§ 371 Date: Nov. 12, 2019

(30) Foreign Application Priority Data
May 19, 2017 (JP) 2017-099782

(51) Int. Cl. G02F 1/1337; G02F 1/1343; G02F 1/1333

(52) U.S. Cl. CPC G02F 1/1337; G02F 1/133345; G02F 1/1343

(57) ABSTRACT

A liquid crystal display panel including a first substrate, a liquid crystal layer, and a second substrate, the first substrate including in the following order to a liquid crystal layer side: a first electrode, an insulating layer, and a second electrode provided with an aperture, the liquid crystal layer containing liquid crystal molecules homogeneously aligned in a no-voltage-applied state, the aperture having an outline including a first outline portion and a second outline portion which are at different directions to each other in each of pixels, the liquid crystal display panel further including a rib protruding to the liquid crystal layer side and disposed between the first outline portion and the second outline portion on one or both of a liquid crystal layer-side surface of the first substrate and a liquid crystal layer-side surface of the second substrate.

### TECHNICAL FIELD

The present invention relates to liquid crystal display panels. The present invention specifically relates to a horizontal electric field mode liquid crystal display panel including an electrode provided with an aperture.

### BACKGROUND ART

Liquid crystal display panels have been used for devices such as televisions, smartphones, tablet PCs, PCs, and car navigation systems. In these usages, various kinds of capabilities have been requested, and various techniques have been proposed (see, for example, Patent Literature 1, Patent Literature 2, and Non-Patent Literature 1).

### CITATION LIST

### Patent Literature

Patent Literature 1: JP 2008-76978 A
Patent Literature 2: JP 2015-114493 A

### Non-Patent Literature

Non-Patent Literature 1: Ishinabe et al., “Substrate and Polymer-Wall Technologies for Future Foldable LCD Applications”, Proc. of IDW, 2016, pp. 91-94

### SUMMARY OF INVENTION

### Technical Problem

Conventional liquid crystal display panels include liquid crystal display panels in a horizontal electric field mode such as the fringe field switching (FFS) mode having better viewing angle characteristics. However, the response time of a horizontal electric field mode liquid crystal display panel may be longer than that of a liquid crystal display panel in a vertical electric field mode such as the vertical alignment (VA) mode. For such a problem, the present inventors found a mode using a FFS mode liquid crystal display panel, in which four liquid crystal domains are formed by rotating liquid crystal molecules in an area smaller than a certain pitch in a voltage-applied state, and the distortion force generated by the bend or spray alignment of the liquid crystal molecules in the small area is used. This mode allows that the liquid crystal molecules in a liquid crystal domain and the liquid crystal molecules in its adjacent liquid crystal domain are rotated in directions opposite to each other to generate the bend or spray alignment distortion of the liquid crystal molecules. Thereby, high-speed response and wide viewing angle are achieved. Further, small pixels a re-formed corresponding to the four liquid crystal domains, achieving high definition.

However, the present inventors found as a result of studies that the liquid crystal display panel in such a mode has a disadvantage that when the no-voltage-applied state (e.g., black display state) is changed to the voltage-applied state (e.g., any of display states of various grayscale values), the alignment disorder of liquid crystal molecules partly occurs, leading to long response time. The liquid crystal display panel examined by the present inventors is described with reference to FIGS. 14 and 15 below. FIG. 14 is a schematic cross-sectional view illustrating a liquid crystal display panel examined by the present inventors. FIG. 15 is a schematic plan view illustrating the liquid crystal display panel examined toy the present inventors. FIG. 15 focuses on the second electrode and the liquid crystal layer in the liquid crystal display panel shown in FIG. 14. A portion taken along the line a-a′ in FIG. 15 corresponds to the cross-sect ion in FIG. 14.

A liquid crystal display panel 101 includes in the following order a first substrate 102, a liquid crystal layer 103, and a second substrate 104.

The first substrate 102 includes in the following order to the liquid crystal layer 103 side: a support substrate 110, a first electrode (common electrode) 111, an insulating layer 112, and a second electrode (pixel electrode) 113.

In each of pixels 106 in the liquid crystal display panel 101, the second electrode 113 is provided with an aperture 114.

The liquid crystal layer 103 contains liquid crystal molecules 107 homogeneously aligned in an initial alignment direction 108 in the no-voltage-applied state where no voltage is applied between the first electrode 111 and the second electrode 113. In contrast, in the voltage-applied state where a voltage is applied between the first electrode 111 and the second electrode 113, a fringe electric field is generated between the first electrode 111 and the second electrode 113 through the aperture 114. As a result, the liquid crystal molecules 107 in the initial alignment direction 108 are rotated to alignments as shown in FIG. 15, and four liquid crystal domains are formed for each aperture 114. However, when the no-voltage-applied state is changed to the voltage-applied state in the liquid crystal display panel 101, the alignment disorder of the liquid crystal molecules 107 partly occurs in some cases as shown in the area surrounded by the dotted line in FIG. 15.

The present inventors made various studies on the cause of the problem and found the following reasons (1) and (2).

(1) The outline of the aperture 114 of the second electrode 113 bends in a small area.
(2) The second electrode 113 includes a large area other than the aperture 114.

Specifically, when the no-voltage-applied state is changed to the voltage-applied state, the alignment direction of the liquid crystal molecules 107 in the region overlapping the aperture 114 is rapidly changed by the fringe electric field, whereas the liquid crystal molecules 107 in the region overlapping the area other than the aperture 114 follow the liquid crystal molecules 107 in the region overlapping the aperture 114 in their alignment directions. As a result, the alignment of the liquid crystal molecules 107 needs a long time to be stabilized, leading to a delay in response time.

The present inventors also found as a result of studies that when no voltage is applied to an isolated pixel 106 and a voltage is applied to its surrounding pixels 106 in the liquid crystal display panel 101, the liquid crystal molecules 107 corresponding to the isolated pixel follow the liquid crystal molecules 107 corresponding to the surrounding pixels in their alignment directions, leading to a state as if the isolated pixel is in the voltage-applied state. As a result, the liquid crystal molecules 107 corresponding to the isolated pixel are not aligned in a desired direction, leading to a delay in response time.

As described above, the horizontal electric field inode liquid crystal display panel needs to be improved to reduce the response time, that is, to achieve high-speed response. However, this problem has not been solved so far. For example, the inventions described in Patent Literature 1, Patent Literature 2, and Non-Patent Literature 1 are insufficient in achieving high-speed response and have room for improvement.

The present invention has been made in view of such a current state of the art and aims to provide a high-speed response horizontal electric field mode liquid crystal display panel.

### Solution to Problem

The present inventors conducted various studies on a high-speed response horizontal electric field mode liquid crystal display panel and focused on forming a structure to prevent the alignment of liquid crystal molecules in a certain area (domain) from being affected by the alignment of liquid crystal molecules in the surrounding areas (domains) in the voltage-applied state, that is, being affected by factors other than a desired fringe electric field. The present inventors also focused on the outline of an aperture provided in the second electrode and found that formation of a rib between the outline portions which are at different directions prevents the alignment of liquid crystal molecules from being affected by factors other than a desired fringe electric field, achieving high-speed response. These findings have now led to completion of the present invention capable of solving the above problem.

That is, one aspect of the present invention may be a liquid crystal display panel including a first substrate; a liquid crystal layer; and a second substrate, the first substrate including in the following order to a liquid crystal layer side: a first electrode, an insulating layer, and a second electrode provided with an aperture, the liquid crystal layer containing liquid crystal molecules homogeneously aligned in a no-voltage-applied state where no voltage is applied between the first electrode and the second electrode, the aperture having an outline including a first outline portion and a second outline portion which are at different directions to each other in each of pixels, the liquid crystal display panel further including a rib protruding to the liquid crystal layer side and disposed between the first outline portion and the second outline portion on one or both of a liquid crystal layer-side surface of the first substrate and a liquid crystal layer-side surface of the second substrate.

The longitudinal direction of the rib may be parallel to the alignment direction of the liquid crystal molecules in the no-voltage-applied state.

The rib may be disposed between adjacent pixels of the pixels.

The rib may be disposed at a position dividing the aperture,

The rib may be disposed at the center of the aperture.

The rib may have a planar shape including a linear portion and a protruding portion protruding from the linear portion.

The rib may be in contact with both the first substrate and the second substrate.

The rib may have a height equal to a distance between a liquid crystal layer-side surface of the insulating layer and the liquid crystal layer-side surface of the second substrate.

### Advantageous Effects of Invention

The present invention can provide a high-speed response horizontal electric field mode, liquid crystal display panel.

### BRIEF DESCRIPTION OF DRAWINGS

FIG. 1 is a schematic cross-sectional view illustrating a liquid crystal display panel according to Embodiment 1.

FIG. 2 is a schematic plan view illustrating the liquid crystal display panel according to Embodiment 1.

FIG. 3 is a schematic plan view illustrating an example of the connection between a second electrode and lines therearound.

FIG. 4 is a schematic cross-sectional view illustrating another example of the position (position example 1) of a rib shown in FIG. 1.

FIG. 5 is a schematic cross-sectional view illustrating yet another example of the position (position example 2) of a rib shown in FIG. 1.

FIG. 6 is a schematic cross-sectional view illustrating a liquid crystal display panel according to Embodiment 2.

FIG. 7 is a schematic plan view illustrating the liquid crystal display panel according to Embodiment 2.

FIG. 8 is a schematic plan view illustrating a liquid crystal display panel according to Embodiment 3.

FIG. 9 is a schematic plan view illustrating a liquid crystal display panel according to Embodiment 4.

FIG. 10 is a schematic plan view illustrating a liquid crystal display panel according to Embodiment 5.

FIG. 11 is a schematic plan view illustrating a liquid crystal display panel according to Embodiment 6.

FIG. 12 is a schematic cross-sectional view illustrating a liquid crystal display panel according to Embodiment 7.

FIG. 13 is a schematic plan view illustrating the liquid crystal display panel according to Embodiment 7.

FIG. 14 is a schematic cross-sectional view illustrating a liquid crystal display panel examined by the present inventors.

FIG. 15 is a schematic plan view illustrating the liquid crystal display panel examined by the present inventors.

### DESCRIPTION OF EMBODIMENTS

Hereinafter, the present invention is described in more detail based on embodiments with reference to the drawings. The embodiments, however, are not intended to limit the scope of the present invention. The configurations of the embodiments may appropriately be combined or modified within the spirit of the present invention.

The expression “X to Y” as used herein means “X or more and Y or less”.

### Embodiment 1

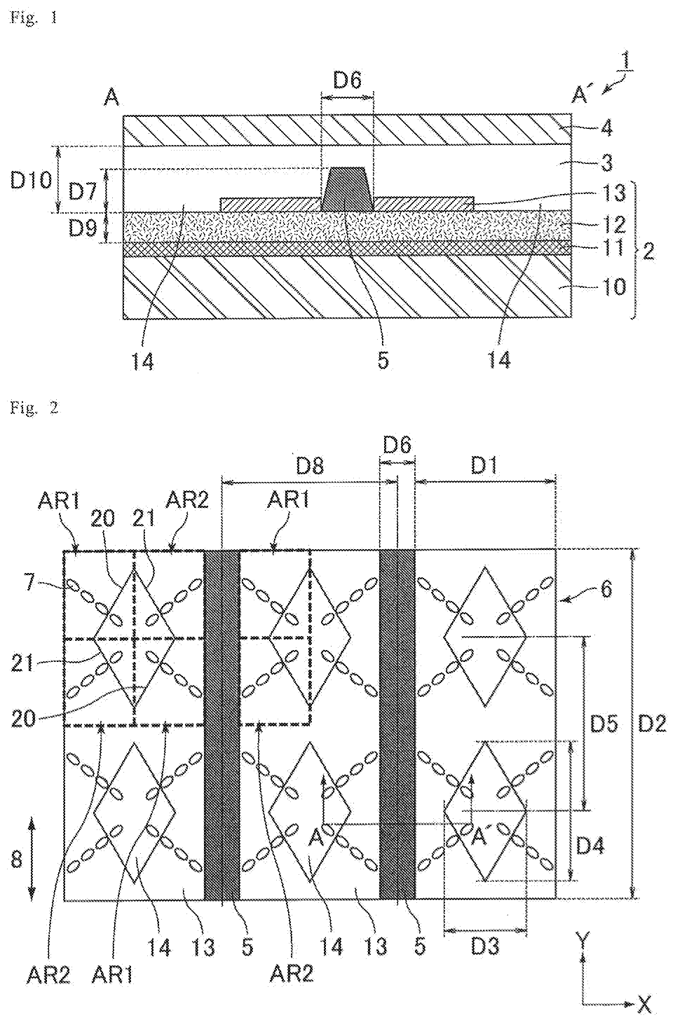

A liquid crystal display panel according to Embodiment 1 is described below with reference to FIGS. 1 and 2. FIG. 1 is a schematic cross-sectional view-illustrating the liquid crystal display panel according to Embodiment 1. FIG. 2 is a schematic plan view illustrating the liquid crystal display panel according to Embodiment 1. FIG. 2 focuses on the second electrode, the liquid crystal layer, and the rib in the liquid crystal display panel shown in FIG. 1. A portion taken along the line A-A′ in FIG. 2 corresponds to the cross-section in FIG. 1.

A liquid crystal display panel 1 includes in the following order a first substrate 2, a liquid crystal layer 3, and a second substrate 4. The liquid crystal display panel 1 further includes a rib 5 protruding to the liquid crystal layer 3 side on the liquid crystal layer 3-side surface of the first substrate 2.

### (First Substrate)

The first substrate 2 includes in the following order to the liquid crystal layer 3 side, a support substrate 10, a first electrode (common electrode) 11, an insulating layer 12, and a second electrode (pixel electrode) 13.

Examples of the support substrate 10 include a glass substrate and a plastic substrate.

The first electrode 11 is a planer electrode with no aperture. Use of the first electrode 11 allows supply of a common voltage to each of pixels 6.

The first electrode 11 may be formed from, for example, a transparent material (inorganic material) such as indium tin oxide (ITO) or indium zinc oxide (IZO).

The insulating layer 12 preferably has a thickness D9 of 0.05 to 1 μm. The insulating layer 12 having a thickness OS of less than 0.05 μm is difficult to form, which may reduce the production efficiency. The insulating layer 12 having a thickness D9 of greater than 1 μm may reduce the transmittance in the voltage-applied state.

The insulating layer 12 may be formed from either an organic insulating material or an inorganic insulating material. An example of the organic insulating material includes polyimide. Examples of the inorganic insulating material include a silicon nitride film, a silicon oxide film, and a silicon oxynitride film. The insulating layer 12 may be a single insulating layer or may be a laminate of multiple insulating layers.

The second electrode 13 is provided with an aperture 14 and is disposed in each pixel 6. The insulating layer 12 and the first electrode 11 are stacked in the stated order from the aperture 14, on the side opposite to the liquid crystal layer 3 side. This structure allows generation of a fringe electric field between the first electrode 11 and the second electrode 13 through the aperture 14 in the voltage-applied state where a voltage is applied between the first electrode 11 and the second electrode 13. That is, the liquid crystal display panel 1 is a horizontal electric field mode liquid crystal display panel.

In each pixel 6, the outline of the aperture 14 of the second electrode 13 includes a first outline portion 20 and a second outline portion 21 which are at different directions to each other. Each pixel 6 includes a first domain AR1 corresponding to the first outline portion 20 and a second domain AR2 corresponding to the second outline portion 21. Here, the expression “the first outline portion 20 and the second outline portion 21 which are at different directions to each other” means that one outline portion rotated by 180° in a plane parallel to the first substrate 2 does not overlap the other outline portion. The angle between the first outline portion 20 and the second outline portion 21 is preferably greater than 0° and 90° or smaller.

The second electrode 13 may be formed from, for example, a transparent material (inorganic material) such as indium tin oxide (ITO) or indium zinc oxide (120).

The aperture 14 may have a polygonal planar shape (including a quadrangular planar shape shown in FIG. 2) or an elliptical planar shape, for example. That is, the first outline portion 20 and the second outline portion 21 of the aperture 14 each may be linear or curved.

The second electrode 13 may be provided with one or more apertures 14.

The length D3 in the X-direction (horizontal length) of the aperture 14 is preferably 2 to 10 μm. When the length D3 in the X-direction of the aperture 14 is less than 2 μm or greater than 10 μm, the transmittance may be reduced.

The length D4 in the f-direction (vertical length) of the aperture 14 is preferably 2 to 20 μm. When the length D4 in the y-direction of the aperture 14 is less than 2 μm or greater than 20 μm, the transmittance may be reduced.

The difference between a distance D5 between the apertures 14 and the length D4 in the Y-direction of the aperture 14 (D5−D4) is preferably greater than 2 μm. When the difference is 2 μm or less, the second electrode 13 (aperture 14) is difficult to pattern.

The second electrode 13 may be connected to the lines therearound as shown in FIG. 3. FIG. 3 is a schematic plan view illustrating an example of the connection between the second electrode and lines therearound. As shown in FIG. 3, gate bus lines 15 and source bus lines 16 are disposed around the second electrode 13. A source electrode 17 is led out from the source bus line 16, and is electrically connected to a drain electrode 19 through a semiconductor layer 18. The drain electrode 19 is electrically connected to the second electrode 13. Although not shown in FIG. 3, in the present embodiment, a rib 5 may be superimposed on the source bus line 16. FIG. 3 is a simplified schematic plan view of the second electrode 13.

The semiconductor layer 18 may be formed from a material such as an amorphous silicon, a polysilicon, or an oxide semiconductor. In order to achieve low power consumption and high-speed driving, an oxide semiconductor is preferred. The oxide semiconductor generates a small amount of off-leakage current to achieve low power consumption and generates a large amount of on-current to achieve high-speed driving. The oxide semiconductor may be formed from a compound such as a compound containing indium, gallium, zinc, and oxygen or; a compound containing indium, tin, zinc, and oxygen.

### (Liquid Crystal Layer)

The liquid crystal layer 3 contains liquid crystal molecules 7 homogeneously aligned in an initial alignment direction 8 in the no-voltage-applied state where no voltage is applied between the first electrode 11 and the second electrode 13. Here, the liquid crystal molecules 7 homogeneously aligned means that the liquid crystal molecules 7 have a pre-tilt angle (angle of inclination in the no-voltage applied state) of 0° to 7° with respect to the surface of the first substrate 2. The alignment direction of the liquid crystal molecules 7 is the major axis direction of the liquid crystal molecules 7 in a plan view of the liquid crystal display panel 1. In the voltage-applied state where a voltage is applied between the first electrode 11 and the second electrode 13, a fringe electric field is generated between the first electrode 11 and the second electrode 13 through the aperture 14. As a result, the liquid crystal molecules 7 in the initial alignment direction 8 are rotated to alignments as shown in FIG. 2, and four liquid crystal domains are formed for each aperture 14. Each liquid crystal domain is formed as a first domain AR1 or a second domain AR2. This structure allows formation of four liquid crystal domains symmetric to each other (symmetric with respect to the X-direction and the Y-direction), leading to the bend or spray alignment distortion of the liquid crystal molecules 7. Thus, high-speed response and wide viewing angle are achieved. Further, small pixels are formed corresponding to the four liquid crystal domains (first domains AR1 and second domains AR2), achieving high definition.

The liquid crystal layer 3 may be formed from a positive liquid crystal material having positive anisotropy of dielectric constant or a negative liquid crystal material having negative anisotropy of dielectric constant. FIG. 2 shows an example of the case of the liquid crystal layer 3 formed from a positive liquid crystal material.

### (Second Substrate)

The second substrate 4 may be, for example, a color filter substrate. The color filter substrate includes a support substrate, a color filter layer on the liquid crystal layer 3 side surface of the support substrate, and a black matrix on the liquid crystal layer 3 side surface of the support substrate. The black matrix is formed separately from the color filter layer.

The color filter layer may be a single-color filter layer or may include color filters of multiple colors. When the color filter layer includes color filters of multiple colors, the combination of colors may be any combination such as a combination of red, green, and blue, a combination of red, green, blue, and yellow, or a combination of red, green, blue, and white.

The color filter layer is formed from a material such as a pigment dispersion color resist.

The black matrix is formed from a material such as a black resist.

### (Rib)

The rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21) in a plan view of the liquid crystal display panel 1. Specifically, the rib 5 is disposed between adjacent pixels 6 (adjacent in the Y-direction). The rib 5 is linear in a plan view.

Since the first domain AR1 and the second domain AR2 are formed based on different; outline portions of the aperture 14 at different directions, the corresponding fringe electric fields are also in different directions. Thus, the alignment of the liquid crystal molecules 7 in the first domain AR1 in the voltage-applied state may be affected by factors other than a desired fringe electric field, that is, may be affected by the fringe electric field in the second domain AR2. According to the continuum theory of liquid crystal, the liquid crystal molecules 7 in the first domain AR1 follow the liquid crystal molecules 7 in the second domain AR2 in their alignment directions. As a result of these, the liquid crystal molecules 7 in the first domain AR1 are not aligned in a desired direction, leading to a delay in response time. Similarly, the liquid crystal molecules 7 in the second domain AR2 are also not aligned in a desired direction in the voltage-applied state, leading to a delay in response time.

On the other hand, in the present embodiment, the rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21), specifically, between adjacent pixels 6. In the adjacent pixels 6 in the voltage-applied state, the first domain AR1 (or second domain AR2) in one pixel 6 and the second domain AR2 (or first domain AR1) in the other pixel 6 are less affected by factors other than a desired fringe electric field. Thus, the liquid crystal molecules 7 can be aligned in the respective desired directions. Further, the rib 5 exerts an alignment controlling force to stabilize the alignment of the liquid crystal molecules 7. As a result of these, high-speed response is achieved. Here, since the alignment controlling force for the liquid crystal molecules 7 is greater in a region close to the rib 5, the high-speed response is greatly achieved by the rib 5 in the present embodiment where small pixels are formed corresponding to the first domains AR1 and the second domains AR2.

The longitudinal direction of the rib 5 is preferably parallel to the alignment direction (initial alignment direction) 8 of the liquid crystal molecules 7 in the no-voltage-applied state. This structure achieves a higher contrast. Here, the expression “the longitudinal direction of the rib 5 is parallel to the initial alignment direction 8 of the liquid crystal molecules 7” means that the angle between these directions is 0° to 5°.

The rib 5 may have any cross section. For example, it may have a trapezoidal cross section as shown in FIG. 1 or may have a rectangular cross section or a square cross section.

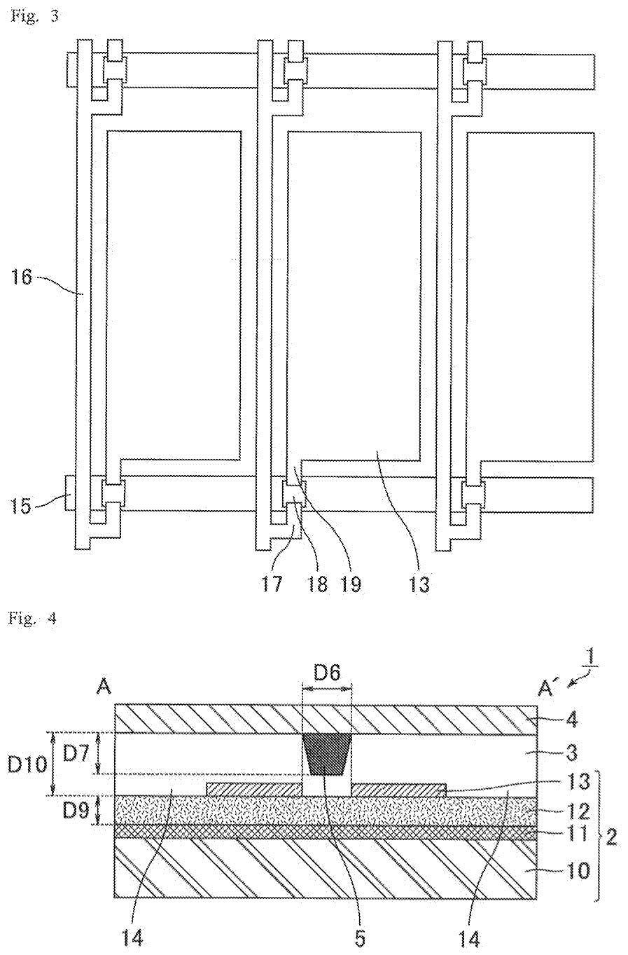

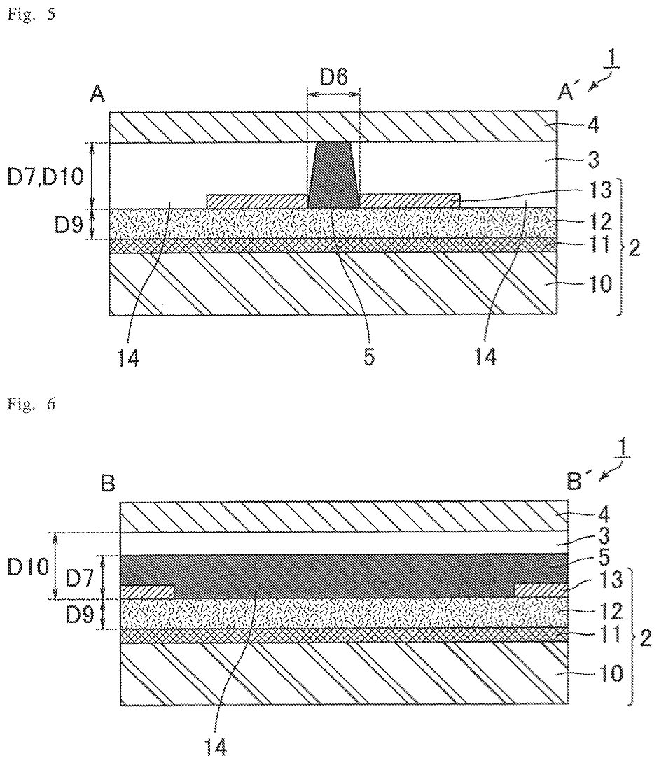

Although the rib 5 is disposed on the liquid crystal layer 3 side surface of the first substrate 2 in FIG. 1, the rib 5 may be disposed on the liquid crystal layer 3 side surface of the second substrate 4 as shown in FIG. 4 or may be disposed on the liquid crystal layer 3 side surface of each of the first substrate 2 and the second substrate 4 as shown in FIG. 5. FIG. 4 is a schematic cross-sectional view illustrating another example of the position (position example 1) of a rib shown in FIG. 1. FIG. 5 is a schematic cross-sectional view illustrating yet another example of the position (position example 2) of a rib shown in FIG. 1. Specifically, the rib 5 may be in contact with the first substrate 2 as shown in FIG. 1, may be in contact with the second substrate 4 as shown in FIG. 4, or may be in contact with both the first substrate 2 and the second substrate 4 as shown in FIG. 5.

The rib 5 preferably has a width D6 as small as possible compared to the size of the pixel 6 (the length D1 in the X-direction (horizontal length) of the pixel 6 and the length D2 in the Y-direction (vertical length) of the pixel 6) from the viewpoint of transmittance. The width is preferably, for example, 0.5 to 3 μm. The rib 5 having a width D6 of less than 0.5 urn may be difficult to form. The rib 5 having a width D6 of greater than 3 μm may reduce the transmittance.

The rib 5 preferably has a height D7 of 1.5 to 4 μm. The rib 5 having a height D7 of less than 1.5 μm may fail to exert a sufficient alignment controlling force. The rib 5 having a height D7 of greater than 4 μm may provide a too large thickness (cell gap) D10 of the liquid crystal layer 3, which may fail to sufficiently reduce the response time. The height D7 of the rib 5 may be equal to the distance between the liquid crystal layer 3 side surface of the insulating layer 12 and the liquid crystal layer 3 side surface of the second substrate 4 as shown in FIG. 5 (where the rib 5 is in contact with both the first substrate 2 and the second substrate 4), that is, the height D7 may be equal to the thickness (cell gap) D10 of the liquid crystal layer 3. This structure allows the use of the rib 5 as a spacer to keep the space (cell gap) between the first substrate 2 and the second substrate 4. As a result, the formation of a spacer other than the rib 5 can be eliminated in the production of the liquid crystal display panel 1, achieving a simple production process. The height D7 of the rib 5 may not equal to the thickness (cell gap) D10 of the liquid crystal layer 3.

The distance D8 between the ribs 5 is preferably 3 to 20 μm. When the distance D8 between the ribs 5 is less than 3 urn, the transmittance may be reduced. When the distance D8 between the ribs 5 is greater than 20 μm, each rib 5 may not exert a sufficient alignment controlling force.

The rib 5 may be formed from a material such as a liquid crystal material or a light-shielding material. Examples of the liquid crystal material include UV-curable liquid crystals available from DIC and reactive mesogens available from Merck. An example of the light-shielding material includes photoresist. An example of a known photoresist includes “S1800” available from Shipley. Use of the rib 5 formed from any of the above materials achieves a higher contrast.

The rib 5 may be formed by the following method, for example. First, a film of photoresist as a material of the rib 5 is formed on the surface of the first substrate 2. Next, the photoresist film is patterned by photolithography to form a desired pattern (pattern of the rib 5 to be formed). Immediately after the patterning, the photoresist is cured by ultraviolet light to prevent the reflow of the photoresist. The ultraviolet light may be applied at any irradiation dose. For example, ultraviolet light having a wavelength of 250 nm may be applied at an irradiation dose of 10 J or less. After the ultraviolet light irradiation, the photoresist is completely cured by heat treatment. Thus, the rib 5 is formed. The heat treatment of the photoresist may be performed in two steps, for example. Specifically, the photoresist may be heated at 120° C. for 40 minutes, followed by heating at 200° C. for 40 minutes.

A horizontal alignment film may be disposed on the liquid crystal layer 3 side surfaces of the first substrate 2 and the rib 5. The horizontal alignment film functions to align the liquid crystal molecules 7 in the vicinity thereof parallel to its surface. Here, the expression “to align the liquid crystal molecules 7 parallel to the surface of the horizontal alignment film” means that the liquid crystal molecules 7 have a pre-tilt angle (angle of inclination in the no-voltage-applied state) of 0° to 7° with respect to the surface of the horizontal alignment film. The surface of the horizontal alignment film may be subjected to an alignment treatment such as a photoalignment treatment or a rubbing treatment, achieving a higher contrast.

When the horizontal alignment film is formed, the surface of the rib 5 may be subjected to a surface modification treatment such as a plasma ashing treatment or a deep UV treatment. Such a treatment increases the wettability of the horizontal alignment film, and the production efficiency is enhanced.

### Embodiment 2

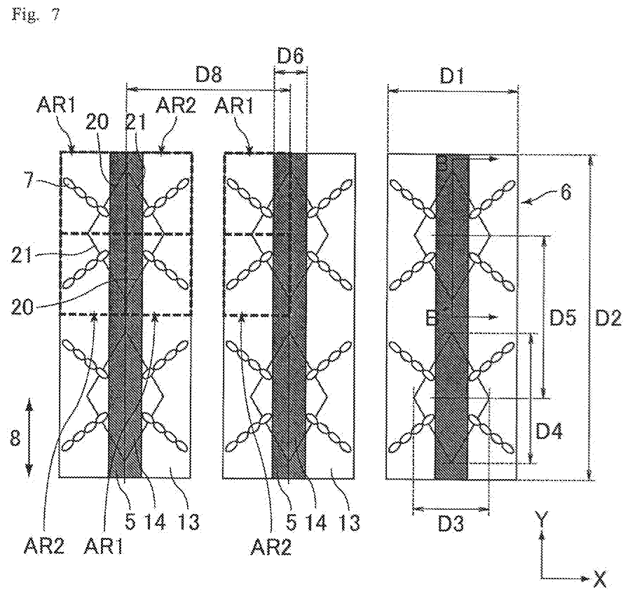

A liquid crystal display panel according to Embodiment 2 is described below with reference to FIGS. 6 and 7. FIG. 6 is a schematic cross-sectional view illustrating the liquid crystal display panel according to Embodiment 2. FIG. 7 is a schematic plan view illustrating the liquid crystal display panel according to Embodiment 2. FIG. 7 focuses on the second electrode, the liquid crystal layer, and the rib in the liquid crystal display panel shown in FIG. 6. A portion taken along the line B-B′ in FIG. 7 corresponds to the cross-section in FIG. 6. Since the liquid crystal display panel according to Embodiment 2 is similar to the liquid crystal display panel according to Embodiment 1 except for the position of the rib, the same features will not be further elaborated here.

The rib 5 is disposed at a position dividing the aperture 14 (in the Y-direction).

In the present embodiment, the rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21) in each pixel 6. In each pixel 6 in the voltage-applied state, the first domain AR1 and the second domain AR2 are less affected by factors other than a desired fringe electric field. Thus, the liquid crystal molecules 7 can be aligned in desired directions. Further, the rib 5 exerts an alignment controlling force to stabilize the alignment of the liquid crystal molecules 7. As a result, high-speed response can be achieved as in Embodiment 1.

### Embodiment 3

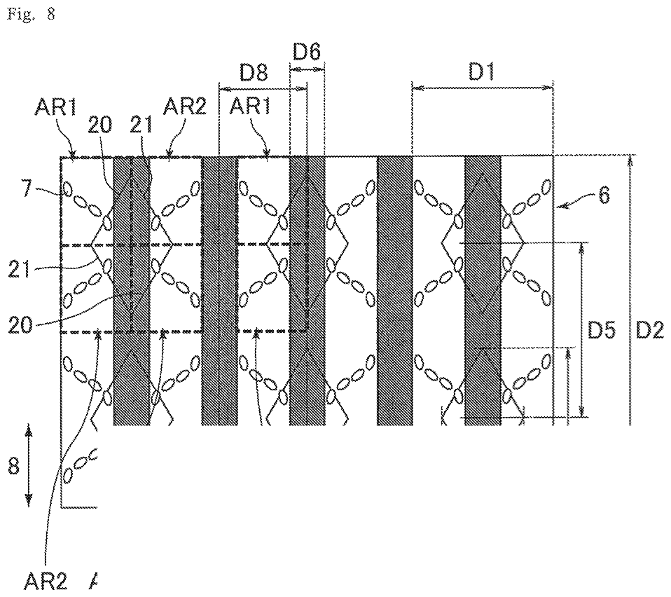

A liquid crystal display panel according to Embodiment 3 is described below with reference to FIG. 8. FIG. 8 is a schematic plan view illustrating the liquid crystal display panel according to Embodiment 3. Since the liquid crystal display panel according to Embodiment 3 is similar to the liquid crystal display panel according to Embodiment 1 (Embodiment 2) except for the position of the rib, the same features will not be further elaborated here.

The rib 5 is disposed each of between adjacent pixels 6 (in the Y-direction) and at a position dividing the aperture 14 (in the Y-direction). That is, in the present embodiment, the rib 5 is disposed at each of the position according to Embodiment 1 and the position according to Embodiment 2.

In the present embodiment, the rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21). Thus, the liquid crystal molecules 7 can be aligned in desired directions in the voltage-applied state as in Embodiment 1 (Embodiment 2). Further, since the rib 5 density is higher in the present embodiment than in Embodiment 1 (Embodiment 2), the alignments of the liquid crystal molecules 7 in the first domain AR1 and the second domain AR2 in the voltage-applied state are less affected by factors other than a desired fringe electric field in the present embodiment than in Embodiment 1 (Embodiment 2). Further, the rib 5 exerts a strong alignment controlling force, leading to the bend alignment distortion of the liquid crystal molecules 7. Thus, the alignment of the liquid crystal molecules 7 are more stable and the response time is shorter in the present embodiment than in Embodiment 1 (Embodiment 2). As a result, high-speed response can be sufficiently achieved.

### Embodiment 4

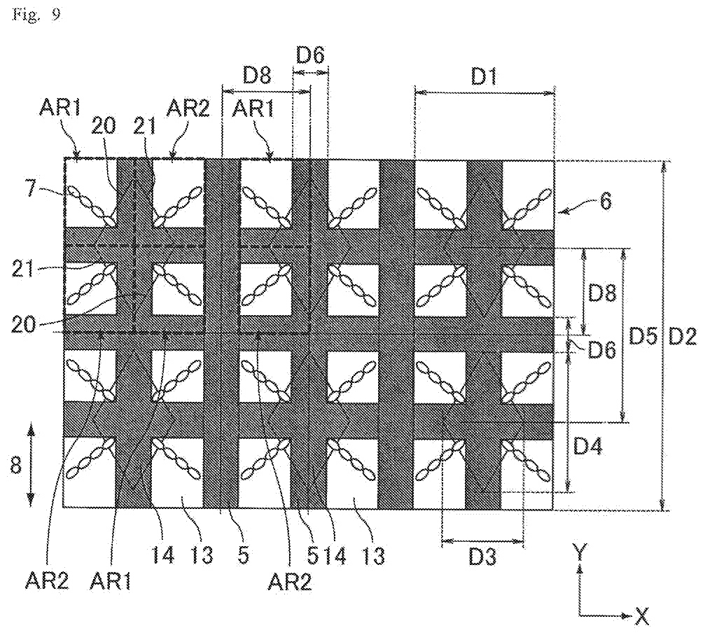

A liquid crystal display panel according to Embodiment 4 is described below with reference to FIG. 9. FIG. 9 is a schematic plan view Illustrating the liquid crystal display panel according to Embodiment 4. Since the liquid crystal display panel according to Embodiment 4 is similar to the liquid crystal display panel according to Embodiment 3 except for the position of the rib, the same features will not be further elaborated here.

The rib 5 is disposed each of between adjacent pixels 6 (in the Y-direction) and at positions dividing the aperture 14 (in the X-direction and in the Y-direction). That is, in the present embodiment, the rib 5 is also disposed at a position dividing the aperture 14 (in the X-direction) as well as the positions according to Embodiment 3.

In the present embodiment, the rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21). Thus, the liquid crystal molecules 7 can be aligned in desired directions in the voltage-applied state as in Embodiment 3. Further, since the rib 5 density is higher in the present embodiment than in Embodiment 3, the alignments of the liquid crystal molecules 7 in the first domain AR1 and the second domain AR2 in the voltage-applied state are less affected by factors other than a desired fringe electric field in the present embodiment than in Embodiment 3. Further, since many ribs 5 are arranged around the first domain AR1 and the second domain AR2, the ribs 5 exert a stronger alignment controlling force in the present embodiment than in Embodiment 3, achieving shorter response time. As a result, high-speed response can be sufficiently achieved.

### Embodiment 5

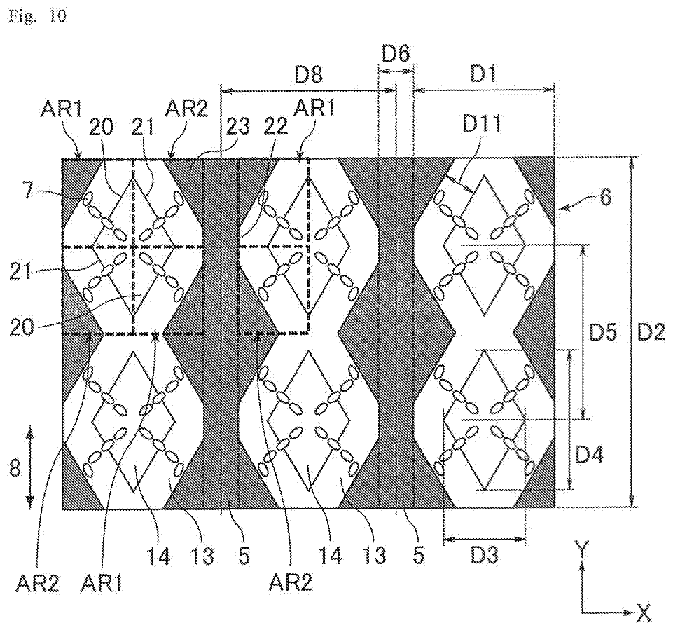

A liquid crystal display panel according to Embodiment 5 is described below with reference to FIG. 10. FIG. 10 is a schematic plan view illustrating the liquid crystal display panel according to Embodiment 5. Since the liquid crystal display panel according to Embodiment 5 is similar to the liquid crystal display panel according to Embodiment 1 except for the shape of the rib, the same features will not be further elaborated here.

The rib 5 is disposed between adjacent pixels 6 (in the Y-direction).

The rib 5 has a planar shape including a linear portion 22 and protruding portions 23 each protruding from the linear portion 22. Specifically, each protruding portion 23 protrudes from the linear portion 22 to the aperture 14. The protruding portion 23 preferably has an outline including as shown in FIG. 10 an outline portion at the same direction as (parallel to) the first outline portion 20 of the aperture 14 and an outline portion at the same direction as (parallel to) the second outline portion 21 of the aperture 14.

In the present embodiment, the rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21). Thus, the liquid crystal molecules 7 can be aligned in desired directions in the voltage-applied state as in Embodiment 1. Further, the presence of the protruding portion 23 of the rib 5 allows reduction of the distance between the rib 5 (protruding portion 23) and the aperture 14. Thus, the alignments of the liquid crystal molecules 7 are more stable due to their bend alignment distortion and the response time is shorter in the present embodiment than in Embodiment 1. As a result, high-speed response can be sufficiently achieved.

The distance D11 between the protruding portion 23 of the rib 5 and the aperture 14 is preferably as small as possible from the viewpoint of stabilizing the alignment of the liquid crystal molecules 7. For example, the distance is preferably 2 to 5 μm. When the distance D11 is less than 2 μm, the rib 5 and the aperture 14 may be difficult to position with each other. When the distance D11 is greater than 5 μm, the rib b may fail to exert a sufficient alignment controlling force.

### Embodiment 6

A liquid crystal display panel according to Embodiment 6 is described below with reference to FIG. 11. FIG. 11 is a schematic plan view illustrating the liquid crystal display panel according to Embodiment 6. Since the liquid crystal display panel according to Embodiment 6 is similar to the liquid crystal display panel according to Embodiment 1 except for the position of the rib, the same features will not be further elaborated here.

The ribs 5 are disposed at intervals between adjacent pixels 6 (in the Y-direction) differently from Embodiment 1, where the rib 5 is disposed entirely between adjacent pixels.

In the present embodiment, the rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21). Thus, the liquid crystal molecules 7 can be aligned in desired directions in the voltage-applied state as in Embodiment 1. Further, since the ribs b are arranged at intervals, the transmittance (aperture ratio) is higher in the present embodiment than in Embodiment 1.

### Embodiment 7

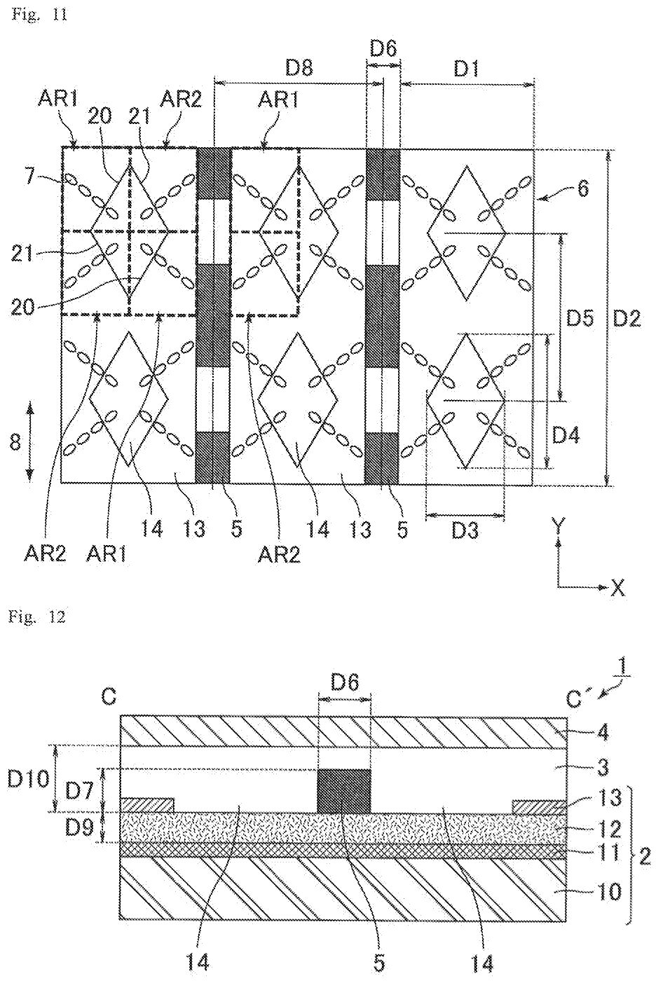

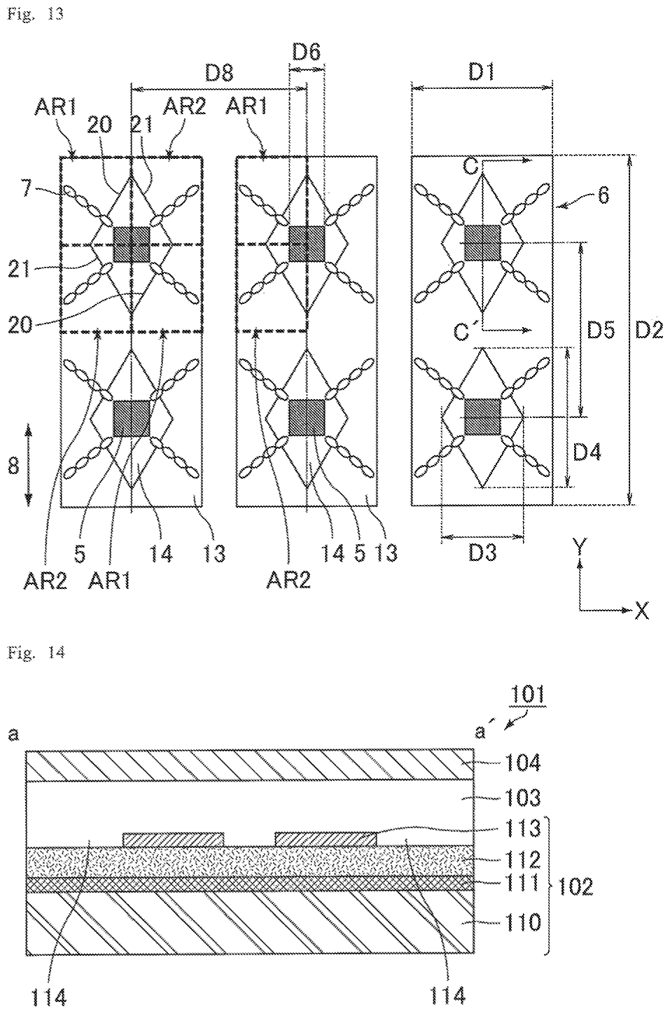

A liquid crystal display panel according to Embodiment 7 is described below with reference to FIGS. 12 and 13. FIG. 12 is a schematic cross-sectional view illustrating the liquid crystal display panel according to Embodiment 7. FIG. 13 is a schematic plan view illustrating the liquid crystal display panel according to Embodiment 7. FIG. 13 focuses on the second electrode, the liquid crystal layer, and the rib in the liquid crystal display panel shown in FIG. 12. A portion taken along the line C-C′ in FIG. 13 corresponds to the cross-section in FIG. 12. Since the liquid crystal display panel according to Embodiment 7 is similar to the liquid crystal display panel according to Embodiment 2 except for the position of the rib, the same features will not be further elaborated here.

The ribs 5 are each disposed at the center of the aperture 14. The arrangement of the ribs 5 is different from that in Embodiment 2 in that the ribs 5 are disposed at intervals (only at the centers of the apertures 14).

In the present embodiment, each rib 5 is disposed between the first outline portion 20 of the aperture 14 (the first domain AR1 corresponding to the first outline portion 20) and the second outline portion 21 of the aperture 14 (the second domain AR2 corresponding to the second outline portion 21). Thus, the liquid crystal molecules 7 can be aligned in desired directions in the voltage-applied state as in Embodiment 2. Further, the rib 5 exerts an alignment controlling force strongly on the center of the aperture 14, effectively reducing the response time. Further, the rib 5 density is lower in the present embodiment than in the Embodiment 2, leading to higher transmittance (aperture ratio),

### EXAMPLES AND COMPARATIVE EXAMPLES

The following describes the response time of a liquid crystal display panel based on simulation results with reference to examples and comparative examples. The present invention is not limited to these examples.

### Example 1

A liquid crystal display panel (simulation sample) according to Example 1 was the liquid crystal display panel according to Embodiment 1 including components having the following parameters.

The length D1 in the X-direction (horizontal length) of the pixel 6: 12 μm

The length D2 in the Y-direction (vertical length) of the pixel 6: 40 μm

The length D3 in the X-direction (horizontal length) of the aperture 14: 7 μm

The length D4 in the Y-direction (vertical length) of the aperture 14: 12 μm

The distance D5 between the apertures 14: 15 μm

The width D6 of the rib 5: 3 μm

The height D7 of the rib 5: 2.5 μm

The distance D8 between the ribs 5: 15 μm

The thickness D9 of the insulating layer 12: 0.1 μm

The thickness (cell gap) D10 of the liquid crystal layer 3: 2.7 μm

### Example 2

A liquid crystal display panel (simulation sample) according to Example 2 was the liquid crystal display panel according to Embodiment 2 including components having the following parameters.

The length D1 in the X-direction (horizontal length) of the pixel 6: 12 μm

The length D2 in the Y-direction (vertical length) of the pixel 6: 40 μm

The length D3 in the X-direction (horizontal length) of the aperture 14: 7 μm

The length D4 in the Y-direction (vertical length) of the aperture 14: 12 μm

The distance D5 between the apertures 14: 15 μm

The width D6 of the rib 5: 3 μm

The height D7 of the rib 5: 2.5 μm

The distance D8 between the ribs 5: 15 μm

The thickness D9 of the insulating layer 12: 0.1 μm

The thickness (cell gap) D10 of the liquid crystal layer 3: 2.7 μm

### Example 3

A liquid crystal display panel (simulation sample) according to Example 3 was the liquid crystal display panel according to Embodiment 3 including components having the following parameters.

The length D1 in the X-direction (horizontal length) of the pixel 6: 12 μm

The length D2 in the Y-direction (vertical length) of the pixel 6: 40 μm

The length D3 in the X-direction (horizontal length) of the aperture 14: 7 μm

The length D4 in the Y-direction (vertical length) of the aperture 14: 12 μm

The distance D5 between the apertures 14: 15 μm

The width D6 of the rib 5: 3 μm

The height D7 of the rib 5: 2.5 μm

The distance D8 between the ribs 5: 7.5 μm

The thickness D9 of the insulating layer 12: 0.1 μm

The thickness (cell gap) D10 of the liquid crystal layer 3: 2.7 μm

### Example 4

A liquid crystal display panel (simulation sample) according to Example 4 was the liquid crystal display panel according to Embodiment. 4 including components having the following parameters.

The length D1 in the X-direction (horizontal length) of the pixel 6: 12 μm

The length D2 in the Y-direction (vertical length) of the pixel 6: 40 μm

The length D3 in the X-direction (horizontal length) of the aperture 14: 7 μm

The length D4 in the Y-direction (vertical length) of the aperture 14: 12 μm

The distance D5 between the apertures 14: 15 μm

The width D6 of the rib 5: 3 μm

The height D7 of the rib 5: 2.5 μm

The distance D8 between the ribs 5: 7.5 μm

The thickness D3 of the insulating layer 12: 0.1 μm

The thickness (cell gap) D10 of the liquid crystal layer 3: 2.7 μm

### Comparative Example 1

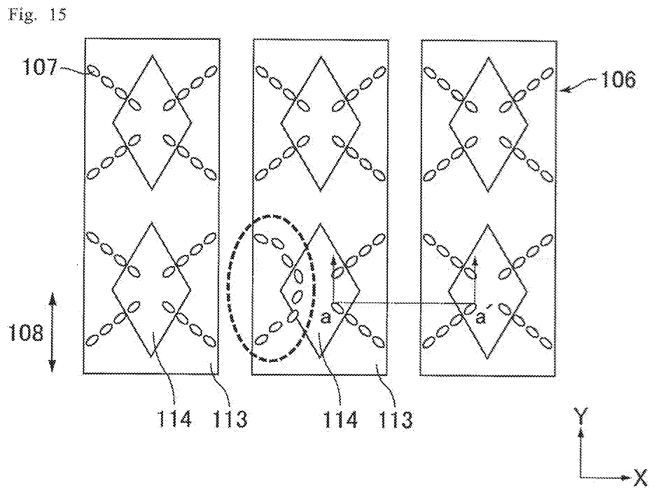

A liquid crystal display panel (simulation sample) according to Comparative Example 1 (the liquid crystal display panel already described above with reference to FIGS. 14 and 15) was the same as the liquid crystal display panel according to Example 1, except that no rib was formed.

### [Evaluation]

For the liquid crystal display panels of the examples, the simulation calculation was performed for the response time when the no-voltage-applied state (grayscale value of 0) was changed to the voltage-applied state (grayscale value of 255) (hereinafter, also referred to as “at rising”) and the response time when the voltage-applied state (grayscale value of 255) was changed to the no-voltage-applied state (grayscale value of 0) (hereinafter, also referred to as “at decaying). The simulation calculation was performed using “LCD Master” available from Symtec Co., Ltd. The voltage-applied state (grayscale value of 255) was assumed to be a state where the potential difference between the first electrode and the second electrode was 4.5 V. Then, using the calculated value of the response time, the percentage of reduction in the response time at each of rising and decaying of each liquid crystal display panel of Examples 1 to 4 relative to the response time of the liquid crystal display panel of Comparative Example 1 was determined using the following formula (A). The results are shown in Table 1. (Percentage of reduction (unit: %) in response time of each liquid crystal display panel of Examples 1 to 4)=(Response time (unit: ms) of liquid crystal display panel of Comparative Example 1−Response time (unit: ms) of each liquid crystal display panel of Examples 1 to 4)/(Response time (unit: ms) of liquid crystal display panel of Comparative Example 1) (A)

TABLE 1

| | Percentage of reduction | |
|---|---|---|
| | in response time (%) | |
| | At rising | At decaying |
| Example 1 | 16 | 14 |
| Example 2 | 8 | 19 |
| Example 3 | 29 | 36 |
| Example 4 | 38 | 49 |

As shown in Table 1, both the response time at rising and the response time at delaying of each liquid crystal display panel of Examples 1 to 4 are shorter than those of the liquid crystal display panel of Comparative Example 1, which demonstrates achievement of high-speed response. The reason why the response time at decaying of each liquid crystal display panel of Examples 1 to 4 is shorten is that, the rib 5 (side face of the rib 5) exerts an alignment controlling force to allow the liquid crystal molecules 7 to return to the original alignment state (initial alignment direction 8) in a short time.

### [Additional Remarks]

One aspect of the present invention may be a liquid crystal display panel inducing a first substrate, a liquid crystal layer, and a second substrate, the first substrate including in the following order to a liquid crystal layer side: a first electrode, an insulating layer, and a second electrode provided with an aperture, the liquid crystal layer containing liquid crystal molecules homogeneously aligned in a no-voltage-applied state where no voltage is applied between the first electrode and the second electrode, the aperture having an outline including a first outline portion and a second outline portion which are at different directions to each other in each of pixels, the liquid crystal display panel further including a rib protruding to the liquid crystal layer side and disposed between the first outline portion and the second outline portion on one or both of a liquid crystal layer-side surface of the first substrate and a liquid crystal layer-side surface of the second substrate. This liquid crystal display panel achieves a high-speed response horizontal electric field mode.

The longitudinal direction of the rib may be parallel to the alignment direction of the liquid crystal molecules in the no-voltage-applied state. This structure achieves a higher contrast.

The rib may be disposed between adjacent pixels. This structure allows that, in adjacent pixels in the voltage-applied state, the domain corresponding to the first outline portion (or the second outline portion) in one pixel and the domain corresponding to the second outline portion (or the first outline portion) in the other pixel are less affected by factors other than a desired fringe electric field. Thus, the liquid crystal molecules can be aligned in desired directions.

The rib may be disposed at a position dividing the aperture. This structure allows that, in each pixel in the voltage-applied state, the domain corresponding to the first outline portion and the domain corresponding to the second outline portion are less affected by factors other than a desired fringe electric field. Thus, the liquid crystal molecules can be aligned in desired directions.

The rib may be disposed at the center of the aperture. This structure allows that the rib 5 exerts an alignment controlling force strongly on the center of the aperture, effectively reducing the response time.

The rib may have a planar shape including a linear portion and a protruding portion protruding from the linear portion. This structure allows that the distance between the rib (protruding portion) and the aperture is reduced. Thus, the alignments of the liquid crystal molecules are further stable due to their bend alignment distortion and the response time is further reduced.

The rib may be in contact with both the first substrate and the second substrate. The rib may have a height equal to a distance between a liquid crystal layer-side surface of the insulating layer and the liquid crystal layer-side surface of the second substrate. This structure allows the use of the rib as a spacer to keep the space (cell gap) between the first substrate and the second substrate. As a result, the formation of a spacer other than the rib 5 can be eliminated in the production of the liquid crystal display panel, achieving a simple production process.

### REFERENCE SIGNS LIST

1, 101; Liquid crystal display panel
2, 102: First substrate
3, 103: Liquid crystal layer
4, 104: Second substrate
5: Rib
6, 106: Pixel
7, 107: Liquid crystal molecule
8, 108: Alignment direction (initial alignment direction) of liquid crystal molecules in no-voltage-applied state
10, 110: Support substrate
11, 111: First electrode (common electrode)
12, 112: Insulating layer
13, 113: Second electrode (pixel electrode)
14, 114: Aperture
15: Gate bus line
16: Source bus line
17: Source electrode
18: Semiconductor layer
19: Drain electrode
20: First; outline portion
21: Second outline portion
22: Linear portion
23: Protruding portion
AR1: First domain
AR2: Second domain
D1: Length in X-direction (horizontal length) of pixel
D2: Length in Y-direction (vertical length) of pixel
D3: Length in X-direction (horizontal length) of aperture
D4: Length in Y-direction (vertical length) of aperture
D5: Distance between apertures
D6: Width of rib
D7: Height of rib
D8: Distance between ribs
D9: Thickness of insulating layer
D10: Thickness (cell gap) of liquid crystal layer
D11: Distance between protruding portion of rib and aperture

1. A liquid crystal display panel comprising:
a first substrate;
a liquid crystal layer; and
a second substrate,
the first substrate including in the following order to a liquid crystal layer side: a first electrode, an insulating layer, and a second electrode provided with an aperture,
the liquid crystal layer containing liquid crystal molecules homogeneously aligned in a no-voltage-applied state where no voltage is applied between the first electrode and the second electrode,
the aperture having an outline including a first outline portion and a second outline portion which are at different directions to each other in each of pixels,
the liquid crystal display panel further comprising a rib protruding to the liquid crystal layer side and disposed between the first outline portion and the second outline portion on one or both of a liquid crystal layer-side surface of the first substrate and a liquid crystal layer-side surface of the second substrate.

2. The liquid crystal display panel according to claim 1,
wherein the longitudinal direction of the rib is parallel to the alignment direction of the liquid crystal molecules in the no-voltage-applied state.

3. The liquid crystal display panel according to claim 1,
wherein the rib is disposed between adjacent pixels of the pixels.

4. The liquid crystal display panel according to claim 1,
wherein the rib is disposed at a position dividing the aperture.

5. The liquid crystal display panel according to claim 1,
wherein the rib is disposed at the center of the aperture.

6. The liquid crystal display panel according to claim 1,
wherein the rib has a planar shape including a linear portion and a protruding portion protruding from the linear portion.

7. The liquid crystal display panel according to claim 1,
wherein the rib is in contact with both the first substrate and the second substrate.

8. The liquid crystal display panel according to claim 7,
wherein the rib has a height equal to a distance between a liquid crystal layer-side surface of the insulating layer and the liquid crystal layer-side surface of the second substrate.
